(19) United States
(12) Patent Application Publication
(10) Pub. No.: US 2011/0300268 A1
(43) Pub. Date: Dec. 8, 2011

(54) Poultry feed and method of making same

(76) Inventor: Raymon W. Lush, Bloomfield, NE (US)

(21) Appl. No.: 12/802,374

(22) Filed: Jun. 4, 2010

(51) Int. Cl. A23K 1/18; A23K 1/175; A23K 1/16; A23K 1/20; A23P 1/12

(52) U.S. Cl. 426/72; 426/622; 426/321; 426/74

(57) ABSTRACT

A poultry feed in the form of weather resistant blocks or logs with the blocks or logs being comprised of ground dry mature sweet corn, water and whole grain.

### BACKGROUND OF THE INVENTION

1. Field of the Invention

This invention relates to poultry feed and the method of making the same and more particularly to poultry feed which is cold extruded to form blocks or logs which are weather resistant. Even more particularly, the poultry feed of this invention is comprised of dry ground mature sweet corn, water and whole grain.

2. Description of the Related Art

Poultry such as chickens, turkeys, ducks, geese, emus, guinea fowl, ostriches, partridges, peafowl, pheasants, quails and swans are fed in many different ways. For example, chickens may be fed by sprinkling grain or the like on the ground so that the chickens may consume the same. This method results in considerable wastage of feed and requires a person to spread the chicken feed. Another method of feeding chickens is to place chicken feed in a pan or feeder. This method also requires some labor and also results in some feed waste.

It is well known that chickens and other poultry breeds may become aggressive when confined in small areas which can lead to destructive behaviors like feather pecking and egg eating. Experts in poultry production recommend that the fowl be provided with appropriate facilities where they can maintain themselves in the most natural manner possible and give the birds something to keep them busy like scratching, digging and pecking.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A method of preparing poultry feed is disclosed comprising the steps of providing ground dry mature sweet corn, providing water, providing whole grain, mixing the sweet corn, water and the whole grain, and cold extruding the mixture to produce blocks or logs. In the preferred method, the sweet corn comprises about 25 to 35 percent of the mixture and the water comprises five to 15 percent of the mixture with the whole grain comprising the rest of the mixture. In the preferred method of making the poultry feed, the whole grain is selected from the group of wheat, oats, barley, maize, brown rice, rye, amaranth, popcorn, speet, emmer, millet, milo, dehulled groats, sorghum, buckwheat, bulgur, quinoa, triticale, faro, kamut, or teff. Other additives and preservatives may be added to the mixture.

The extruded block or log is weather resistant so that the block or log remains substantially intact until the block or log has been consumed by the bird(s).

It is therefore a principal object of the invention to provide an improved poultry feed.

A further object of the invention is to provide a poultry feed which is in the form of a weather resistant block or log.

A further object of the invention is to provide a poultry feed which is comprised of ground dry mature sweet corn, water and whole grain.

A further object of the invention is to provide a poultry feed which is comprised of ground dry mature sweet corn, water, whole grain and other additives.

These and other objects will be apparent to those skilled in the art.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

In the preferred embodiment, ground dry mature sweet corn is mixed with water and whole grain. Preferably, the ground dry mature sweet corn comprises about 25 to 35 percent of the mixture. In the preferred embodiment, the water in the mixture comprises about five to 15 percent of the mixture. The amount of whole grain will depend upon the amount of ground dry mature sweet corn and water used in the mixture. The whole grain is selected from the group of wheat, oats, barley, maize, brown rice, rye, amaranth, popcorn, speet, emmer, millet, milo, dehulled groats, sorghum, buckwheat, bulgur, quinoa, triticale, faro, kamut, or teff. In addition, other minerals, additives and preservatives may be added to the mixture. The mixture is cold extruded by means of a cold extrusion machine so that an elongated extruded product is achieved which may be either square, rectangular or cylindrical in cross-section. The extruded product may then be sliced or cut into blocks or logs.

Example No. 1 reproduced herein below is a mixture of 60 percent whole grain, 25 percent dry ground mature sweet corn and 15 percent water.

### Example No. 1 (60-25-15)

| | |
|---|---|
| 1200 lbs | Whole grain |
| 500 lbs | Ground dry mature sweet corn |
| 300 lbs | H2o |
| 2000 lb | Batch |

In Example No. 2 below, the mixture is comprised of 60 percent whole grain, 30 percent dry ground mature sweet corn and 10 percent water.

### Example No. 2 (60-30-10)

| | |
|---|---|
| 1200 lbs | Whole grain |
| 600 lbs | Ground dry mature sweet corn |
| 300 lbs | H2o |
| 2000 lb | Batch |

In Example No. 3, the whole grain comprises 60 percent of the mixture with the dry ground mature sweet corn comprising 35 percent of the mixture and the water comprising five percent of the mixture.

### Example No. 3 (60-35-5)

| | |
|---|---|
| 1200 lbs | Whole grain |
| 700 lbs | Ground dry mature sweet corn |
| 100 lbs | H2o |
| 2000 lb | Batch |

In Example No. 4 hereinbelow, the 2500 pound batch is mixed and cold extruded in the amounts set forth therein.

### Example No. 4

| | |
|---|---|
| 50 lb | Whole black oil sunflower seeds |
| 500 lb | Millet |
| 300 lb | Milo |
| 200 lb | Barley |
| 100 lb | Cracked corn |
| 100 lb | Whole wheat |
| 50 lb | Oyster shell |
| 30 lb | Salt |
| 25 lb | Dical |
| 30 lb | Calcium propionate |
| 15 lb | Citric acid |
| 800 lb | Ground dry mature sweet corn |
| 300 lb | Water |
| 2500 lb | Batch |

The resultant block or log is very dense and the chickens or other fowl may peck at the block or log to consume the whole grain and sweet corn in the block or log. The requirement that the chickens or other fowl peck at the block or log to consume the sweet corn or whole grain gives the chickens something to do to reduce the aggressive behavior sometimes associated with chickens.

The resultant block or log is extremely weather resistant and will remain substantially intact until it has been consumed by the poultry. Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A method of feeding poultry, comprising the steps of:
providing a predetermined quantity of ground dry mature sweet corn;
providing a predetermined quantity of water;
providing a predetermined quantity of whole grain;
mixing the sweet corn, water and whole grain;
cold extruding the mixture under pressure to produce blocks or logs; and
feeding the blocks or logs to poultry.

2. The method of claim 1 wherein the dry ground mature sweet corn comprises about 25 to 35 percent of the mixture.

3. The method of claim 1 wherein the water comprises about five to 15 percent of the mixture.

4. The method of claim 1 wherein the whole grain is selected from the group of wheat, oats, barley, maize, brown rice, rye, amaranth, popcorn, speet, emmer, millet, milo, dehulled groats, sorghum, buckwheat, bulgur, quinoa, triticale, faro, kamut or teff.

5. The method of claim 1 wherein a predetermined quantity of sunflower seeds are added to the mixture.

6. The method of claim 1 wherein a predetermined quantity of beans are added to the mixture.

7. The method of claim 1 wherein a predetermined quantity of peas are added to the mixture.

8. The method of claim 1 wherein a predetermined quantity of preservative is added to the mixture.

9. The method of claim 1 where a predetermined quantity of nuts are added to the mixture.

10. The method of claim 1 wherein a predetermined quantity of minerals are added to the mixture.

11. The method of claim 1 wherein a predetermined quantity of vitamins are added to the mixture.

12. The method of claim 1 wherein a predetermined quantity of oyster shells are added to the mixture.

13. The method of preparing poultry feed comprising the steps of:
providing ground dry mature sweet corn;
providing water;
providing whole grain;
mixing the sweet corn, water and the whole grain; and
cold extruding the mixture to produce blocks, logs or the like.

14. The method of claim 1 wherein the sweet corn comprises about 25 to 35 percent of the mixture.

15. The method of claim 1 wherein the water comprises about five to 15 percent of the mixture.

16. The method of claim 1 wherein the whole grain is selected from the group of wheat, oats, barley, maize, brown rice, rye, amaranth, popcorn, speet, emmer, millet, milo, dehulled groats, sorghum, buckwheat, bulgur, quinoa, triticale, faro, kamut or teff.

17. A cold extruded poultry feed block or log comprising ground mature sweet corn, water and whole grain.

18. The poultry feed block or log of claim 17 wherein the sweet corn comprises about 25 to 35 percent of the extruded product.

19. The method of claim 18 wherein the water comprises about five to 15 percent of the mixture.

20. The poultry feed block or log of claim 17 wherein the whole grain is selected from the group of is selected from the group of wheat, oats, barley, maize, brown rice, rye, amaranth, popcorn, speet, emmer, millet, milo, dehulled groats, sorghum, buckwheat, bulgur, quinoa, triticale, faro, kamut or teff.

21. The poultry feed block or log of claim 20 wherein the product also includes one or more of the following ingredients, namely vitamins, minerals, oyster shells, sunflower seeds, beans, nuts, peas, salt, citric acid and preservative.
